(19) United States
(12) Patent Application Publication
(10) Pub. No.: US 2008/0044792 A1
(43) Pub. Date: Feb. 21, 2008

(54) Dental extraction device

(76) Inventor: Timothy J. Roberts, Great Falls, MT (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/894,015

(22) Filed: Aug. 16, 2007

Related U.S. Application Data
(60) Provisional application No. 60/838,738, filed on Aug. 17, 2006.

(51) Int. Cl. A61C 3/14

(52) U.S. Cl. 433/159

(57) ABSTRACT

A dental extraction device. The dental extraction device includes a quick-release shaft, a pliers assembly pivotably coupled to the quick-release shaft, a handle, a lock mechanism to selectively secure the quick-release shaft in a fixed position relative to the handle, and an adjustment mechanism moveably coupled to the handle. Movement of the adjustment mechanism relative to the handle actuates the pliers assembly.

### CROSS REFERENCE TO RELATED APPLICATIONS

This application claims the benefit of U.S. Provisional Application No. 60/838,738, filed Aug. 17, 2006, the entirety of which is hereby incorporated herein by reference for all purposes.

### BACKGROUND

Dental extraction devices may be used to extract teeth. There are several types of dental extraction devices that generally include a handle and some type of pliers head for gripping a tooth. The gripping head of a dental extraction device is typically designed to grasp the tooth with maximum contact on the surface of the tooth, and thus is shaped to fit the contours of the tooth. The gripping head can be angled according to the location of the tooth within a mouth to maximize surface contact with the tooth. A dentist often needs several different tools, each having a particularly configured gripping head, for extracting different sizes and shapes of teeth at different locations within a mouth.

Even when a dentist has access to a full range of different dental extraction devices, such conventional dental extraction devices require a dentist to possess substantial gripping strength and endurance in order to continually apply adequate force to maintain a secure hold on the tooth that is being extracted.

### BRIEF DESCRIPTION OF THE DRAWINGS

FIG. 1 is an exploded view of a dental extraction device according to an embodiment of the present disclosure.

FIGS. 2A and 2B show actuation of a pliers mechanism of the dental extraction device of FIG. 1.

FIGS. 3A and 3B are cross-sectional views showing a lock mechanism of the dental extraction device of FIG. 1.

### WRITTEN DESCRIPTION

The present disclosure relates to a device for extracting teeth. The device can include a pliers assembly that may be quickly and easily interchanged with another pliers assembly to accommodate teeth of different sizes and shapes. The device additionally or alternatively can include a clamping lock that allows a tooth to be gripped without requiring an operator to continually apply a sustained gripping force to the device. One or both of these concepts can be embodied in a variety of different devices. The following description is directed to a nonlimiting example of one such device that includes an interchangeable tooth-gripping head and a user-operable grip lock. It should be understood that various changes in form and detail can be made to the below described embodiment without departing from the spirit and scope of the present disclosure.

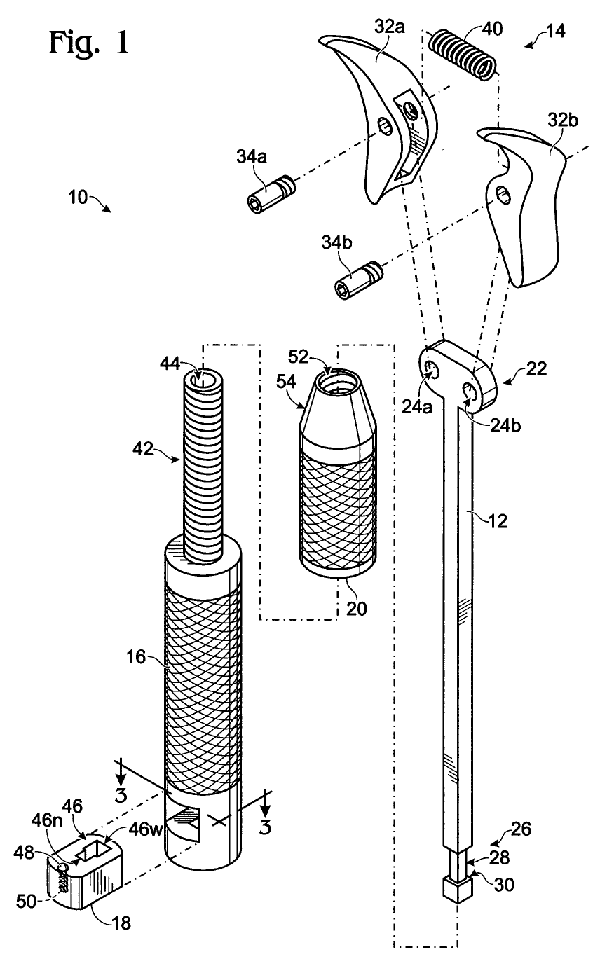

FIG. 1 shows a nonlimiting example of a dental extraction device 10. Dental extraction device 10 includes a quick-release shaft 12, a pliers assembly 14, a handle 16, a lock mechanism 18, and an adjustment mechanism 20. As described in more detail below, the adjustment mechanism is used to cause the pliers assembly to clamp onto a tooth and maintain clamping pressure without requiring significant grip strength from the operator. Quick-release shaft 10 is one of a plurality of interchangeable quick-release shafts that are pivotably coupled to different pliers assemblies. In other words, each quick-release shaft is used to hold one of a variety of differently sized and shaped pliers assemblies. The lock mechanism is used to lock and unlock the quick-release shaft within the handle, so that different pliers assemblies can be used with the dental extraction device.

As shown in FIG. 1, quick-release shaft 10 has an elongated shape. The quick-release shaft has a working end 22 that includes transversely spaced apart pivots 24a and 24b. The quick-release shaft also has a locking end 26 that includes a narrow engagement portion 28 and a relatively wide shoulder 30 adjacent to the narrow engagement portion. It should be understood that differently sized and shaped quick-release shafts are within the scope of this disclosure. Furthermore, some embodiments may not include a quick-release shaft. Such embodiments may provide quick-release functionality directly between the pliers assembly and the handle or through a different mechanism.

Pliers assembly 14 is pivotably coupled to the quick-release shaft at transversely spaced apart pivots 24a and 24b. The pliers assembly includes opposing jaws 32a and 32b, which are pivotably linked to the working end of the quick-release shaft by pivot bolts 34a and 34b, respectively.

Opposing jaws 32a and 32b are shaped for gripping a tooth. The illustrated jaws are provided as a nonlimiting example, and other jaws can be used for extracting a variety of differently sized and shaped teeth. Furthermore, jaws that are suitable for gripping objects other than teeth can be used without departing from the scope of this disclosure, and devices utilizing such jaws are considered to be within the scope of the present invention.

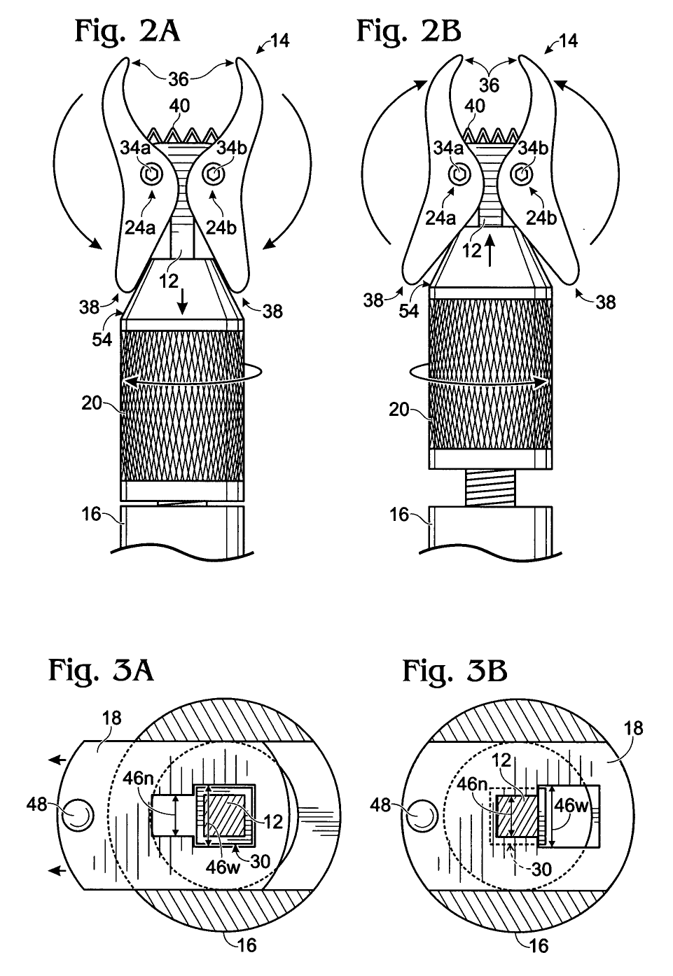

As best shown in FIGS. 2A and 2B, each opposing jaw includes a gripping end 36 and a spreading end 38. The pliers assembly also includes a spring 40, which biases the gripping ends of the opposing jaws apart. The location of the pivots causes the gripping ends to pinch together against the biasing of the spring responsive to the spreading ends being forced apart, as explained in more detail below.

Turning back to FIG. 1, handle 16 includes a threaded portion 42. Threaded portion 42 is complementarily threaded relative to adjustment mechanism 20, so that the adjustment mechanism can screw onto and off of the handle. Handle 16 defines a longitudinally extending inner cavity 44, into which the quick-release shaft can extend. In the illustrated embodiment, inner cavity 44 extends to an opening 46 in the side of the handle.

Opening 46 receives lock mechanism 18, and allows the lock mechanism to move between an open and a locked position. Lock mechanism 18 can be used to selectively secure quick-release shaft 12 in a fixed position relative to handle 16. In other words, the lock mechanism can be used to lock the quick-release shaft into the handle when the lock mechanism is in a locked position, and to allow the quick-release shaft to be removed from the handle when the lock mechanism is in an open position.

Lock mechanism 18 defines a passage 46 having a narrow portion 46n and a wide portion 46w. As best shown in FIGS. 3A and 3B, the lock mechanism is moveable between an open position (FIG. 3A) and a closed position (FIG. 3B). The quick-release shaft can extend through passage 46 when the lock mechanism is in the open position and when the lock mechanism is in the locked position. In the open position, wide portion 46w aligns with quick-release shaft 12. In this configuration, the quick-release shaft can be moved through the lock-mechanism so that it can be removed from the handle. This is possible because shoulder 30 of the quick-release shaft is sized to fit through wide portion 46w of passage 46. In the closed position, narrow portion 46n of passage 46 aligns with quick-release shaft 12. In this configuration, the quick-release shaft cannot be moved through the lock mechanism because shoulder 30 is obstructed by narrow portion 46n of passage 46. In other words, the lock mechanism can snuggly fit around the engagement portion of the quick-release shaft, thereby obstructing translational movement of the shoulder of the quick release shaft.

When a user wants to secure a particular quick-release shaft in the handle, the user can move the lock mechanism to the open position (FIG. 2A) and insert the desired quick-release shaft. Then the user can move the lock-mechanism to the locked position (FIG. 3B). If the user wishes to change quick-release shafts, the user can move the lock mechanism into the open position, remove one quick-release shaft, insert another quick-release shaft, and return the lock-mechanism to the locked position.

Lock mechanism 18 includes a catch 48 resiliently biased to engage a complementary portion of the handle when the lock mechanism is in the locked position, so as to facilitate holding the lock mechanism in the locked position. Handle 16 can include a detent with which catch 48 aligns when the lock mechanism is in the locked position. The catch can be biased into the detent, thus helping the lock mechanism stay in the locked position. In the illustrated embodiment, the lock mechanism includes a well, with a spring 50 positioned within the well to bias the catch outward.

The above described quick-release mechanisms are provided as nonlimiting examples. Different pliers assemblies may be quickly and easily attached to a handle using other mechanisms without departing from the scope of this disclosure.

Turning back to FIG. 1, adjustment mechanism 20 defines an inner orifice 52 through which the quick-release shaft can extend. The inner orifice is complementarily threaded relative to threaded portion 42 of handle 16, so that the adjustment mechanism can be screwed onto the handle. When screwed onto the handle, a quick-release shaft can be inserted through orifice 52 and into inner cavity 44 of the handle. The quick-release shaft can be selectively secured to the handle as described above.

The adjustment mechanism can be screwed onto and off of the handle, thus causing the adjustment mechanism to move relative to the quick-release shaft and the pliers assembly coupled to the quick-release shaft. Movement of the adjustment mechanism relative to the handle actuates the pliers assembly. As best shown in FIGS. 2A and 2B, the adjustment mechanism can include a ramped surface 54 that is shaped to engage the spreading ends 38 of the pliers assembly. When the adjustment mechanism is screwed away from the handle (FIG. 2B), ramped surface 54 moves into the spreading ends of the pliers assembly, thus progressively spreading the spreading ends as the adjustment mechanism moves further into the spreading ends. As the spreading ends are separated by the ramped surface of the adjustment mechanism, the gripping ends 36 of the pliers assembly pinch together. In this way, the dental extraction device can clamp onto a tooth or other object.

Once the pliers assembly is clamped onto a tooth, the jaws of the pliers assembly will continue to grip the tooth without requiring continued effort from the operator, because the adjustment mechanism holds the pliers assembly in a pinched position. In other words, once clamped, the tool operator does not need to use hand strength to maintain the clamping. To unclamp the tooth, the operator can screw the adjustment portion away from the pliers assembly (FIG. 2A), allowing the spreading ends of the jaws to move closer together while the gripping ends of the jaws open.

The above described clamping mechanism is provided as a nonlimiting example. Different clamping mechanisms may be used to hold a pliers assembly in a clamped configuration without requiring continued effort from an operator.

It should be understood that the size and/or shape of a dental extraction device can be adapted to fit a variety of different operator's hands and or a variety of different patient's teeth and mouths. Furthermore, it should be understood that the tool can be made from a variety of different materials. As nonlimiting examples, at least portions of the tool can be made from stainless steel or titanium.

1. A dental extraction device, comprising:
an elongated quick-release shaft including a working end and a locking end, the working end including transversely spaced apart pivots;
a pair of opposing jaws, the opposing jaws each having a gripping end and a spreading end, the opposing jaws being pivotally connected to the quick-release shaft at the transversely spaced apart pivots such that the gripping ends pinch together responsive to the spreading ends moving apart;
a handle including a threaded portion, the handle defining a longitudinally extending inner cavity into which the quick-release shaft extends;
a lock moveable between an open position and a locked position, the lock allowing the quick-release shaft to be removed from the handle when in the open position, and the lock engaging the locking end of the quick-release shaft when in the locked position to secure the quick-release shaft in a fixed position relative to the handle; and
an adjustment dial including a ramped surface and defining an inner orifice through which the quick-release shaft extends, the adjustment dial being complementarily threaded relative to the threaded portion of the handle so that screwing the adjustment dial away from the handle effectuates movement of the ramped surface into the spreading ends of the opposing jaws, thereby moving apart the spreading ends of the opposing jaws and pinching together the gripping ends of the opposing jaws.

2. The dental extraction device of claim 1, where the quick-release shaft is one of a plurality of interchangeable quick-release shafts that are pivotably coupled to different pliers assemblies.

3. The dental extraction device of claim 2, where the locking end of the quick-release shaft includes a narrow engagement portion adjacent to a shoulder.

4. The dental extraction device of claim 3, where the lock secures the quick-release shaft in a fixed position relative to the handle when in the locked position by fitting around the engagement portion of the quick-release shaft, thereby obstructing translational movement of the shoulder of the quick-release shaft.

5. The dental extraction device of claim 1, where a side of the handle includes an opening through which the lock moves between the open position and the locked position.

6. The dental extraction device of claim 1, where the lock includes a catch resiliently biased to engage a complementary portion of the handle when the lock is in the locked position so as to facilitate holding the lock in the locked position.

7. The dental extraction device of claim 6, where the lock includes a well and a spring positioned at least partially within the well, the spring biasing the catch away from the well.

8. The dental extraction device of claim 1, further comprising a spring that biases the gripping ends of the opposing jaws apart.

9. A dental extraction device, comprising:
a quick-release shaft;
a pliers assembly pivotably coupled to the quick-release shaft;
a handle;
a lock mechanism to selectively secure the quick-release shaft in a fixed position relative to the handle; and
an adjustment mechanism moveably coupled to the handle, where movement of the adjustment mechanism relative to the handle actuates the pliers assembly.

10. The dental extraction device of claim 8, where the quick-release shaft is one of a plurality of interchangeable quick-release shafts that are pivotably coupled to different pliers assemblies.

11. The dental extraction device of claim 9, where:
the lock mechanism defines a passage having a narrow portion and a wide portion;
the quick-release shaft includes an engagement portion adjacent to a shoulder, the shoulder sized to fit through the wide portion of the passage but to be obstructed by the narrow portion of the passage;
the lock mechanism is moveable between at least an open position that aligns the wide portion of the passage with the quick-release shaft and a locked position that aligns the narrow portion of the passage with the quick-release shaft, such that the wide portion of the passage allows the quick-release shaft to be removed from the handle when the lock mechanism is in the open position and the narrow portion of the passage prevents the quick-release shaft from being removed from the handle by obstructing the shoulder when the lock mechanism is in the locked position.

12. The dental extraction device of claim 11, where a side of the handle includes an opening through which the lock mechanism moves between the open position and the locked position.

13. The dental extraction device of claim 11, where the lock mechanism includes a catch resiliently biased to engage a complementary portion of the handle when the lock mechanism is in the locked position so as to facilitate holding the lock mechanism in the locked position.

14. The dental extraction device of claim 13, where the lock mechanism includes a well and a spring positioned at least partially within the well, the spring biasing the catch away from the well.

15. The dental extraction device of claim 9, where the pliers mechanism includes opposing jaws, each jaw having a gripping end and a spreading end, the opposing jaws being pivotally connected to the quick-release shaft such that the gripping ends pinch together responsive to the spreading ends moving apart.

16. The dental extraction device of claim 15, where the handle and the adjustment mechanism are complementarily threaded so that screwing the adjustment mechanism away from the handle effectuates longitudinal movement of the adjustment mechanism into the spreading ends of the opposing jaws.

17. The dental extraction device of claim 16, where the adjustment mechanism includes a ramped surface that moves the spreading ends of the opposing jaws apart as the adjustment mechanism moves into the spreading ends of the opposing jaws.

18. The dental extraction device of claim 9, where the handle defines a longitudinally extending inner cavity into which the quick-release shaft extends.

19. The dental extraction device of claim 18, where the adjustment mechanism defines an inner orifice through which the quick-release shaft extends.

20. A dental extraction device, comprising:
an elongated quick-release shaft;
a pair of opposing jaws pivotally connected to the quick-release shaft;
a handle defining a longitudinally extending inner cavity into which the quick-release shaft extends; and
a lock moveable between an open position and a locked position, the lock allowing the quick-release shaft to be removed from the handle when in the open position, and the lock engaging the quick-release shaft when in the locked position to secure the quick-release shaft in a fixed position relative to the handle.
